(19) United States
(12) Patent Application Publication
(10) Pub. No.: US 2011/0314236 A1
(43) Pub. Date: Dec. 22, 2011

(54) Control apparatus, control method, and storage system

(75) Inventors: Atsushi Uchida, Kawasaki (JP); Yuji Hanaoka, Kawasaki (JP); Yoko Kawano, Kawasaki (JP); Nina Tsukamoto, Kawasaki (JP)

(73) Assignee: FUJITSU LIMITED, Kawasaki (JP)

(21) Appl. No.: 13/067,132

(22) Filed: May 11, 2011

(30) Foreign Application Priority Data
Jun. 17, 2010 (JP) 2010-137880

(51) Int. Cl. G06F 12/00

(52) U.S. Cl. 711/156; 711/154; 711/E12.001

(57) ABSTRACT

In a control apparatus, a write control unit controls operation of writing data to a non-volatile storage unit. The write control unit is configurable with given control data. A control data storage unit stores first control data for the write control unit. An input reception unit receives second control data for the write control unit. A configuration unit configures the write control unit with the first control data stored in the control data storage unit when the first control data has a newer version number than that of the second control data received by the input reception unit, and with the second control data when the second control data has a newer version number than that of the first control data.

### CROSS-REFERENCE TO RELATED APPLICATION

This application is based upon and claims the benefit of priority of the prior Japanese Patent Application No. 2010-137880, filed on Jun. 17, 2010, the entire contents of which are incorporated herein by reference.

### FIELD

The embodiments discussed herein relate to a control apparatus, a control method, and a storage system.

### BACKGROUND

Non-volatile storage media such as flash memory are used for various purposes including data backup. FIG. 13 illustrates an example of a device using non-volatile storage media. The illustrated control apparatus 90 controls a storage device 91 including hard disk drives (HDD), solid state drives (SSD), and the like. This control apparatus 90 includes, among others, a CPU 90a, and a cache memory 90b and CPU flash memory 90f for use by the CPU 90a.

The control apparatus 90 further includes a flash memory 90d to back up data in the cache memory 90b when the power for the control apparatus 90 is interrupted. Backup operation is executed by a field-programmable gate array (FPGA) 90c to save data from the cache memory 90b to the flash memory 90d. Specifically, FPGA data is previously stored in, for example, the storage device 91 to define the backup operation to be performed by the FPGA 90c. This FPGA data is read out of the storage device 91 by the CPU 90a and stored in the CPU flash memory 90f at an appropriate time. To configure the FPGA 90c, the CPU 90a reads FPGA data out of the CPU, flash memory 90f and feeds it to the FPGA 90c through a programmable-logic device (PLD) 90e. (See, for example, Japanese Laid-open Patent Publication No. 11-95994)

The manufacturer of flash memory devices may change their products for the purposes of, for example, chip size reduction. The manufacturer may even discontinue the production of a particular device model. Those changes of flash memory necessitate a modification of circuit design of the control apparatus to use new or alternative flash memory devices which may not work with the current control method designed for the previous devices. This leads to a situation where the same storage device has to be controlled by a modified version of control apparatus which uses a different method to control flash memory devices mounted thereon.

For example, the control apparatus 90 in FIG. 13 is supposed to be able to control the same storage device 91 even if the flash memory 90d used in the control apparatus 90 is changed. FPGA data stored in the storage device 91 may not always be compatible with the new flash memory 90d in terms of control methods. The FPGA 90c, if configured with such an incompatible FPGA data in the storage device 91, would not operate in the intended way.

Configuration of the FPGA 90c may be initiated by an administrator, not under the control of the CPU 90a. This method, however, may introduce some human error, and it is practically difficult to avoid such problems.

### SUMMARY

According to an aspect of the invention, there is provided a control apparatus which includes the following elements: a non-volatile storage unit to store data; a write control unit, configurable with given control data, to control operation of writing data to the non-volatile storage unit; a control data storage unit to store first control data for the write control unit; an input reception unit to receive second control data for the write control unit from an external source; and a configuration unit to configure the write control unit with the first control data stored in the control data storage unit when the first control data has a newer version number than that of the second control data received by the input reception unit, and with the second control data when the second control data has a newer version number than that of the first control data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 gives an overview of a control apparatus according to a first embodiment;

FIG. 2 is a block diagram illustrating a storage system according to a second embodiment;

FIG. 3 illustrates an example of a drive enclosure;

FIG. 4 is a block diagram illustrating functions of a control module;

FIG. 5 is a block diagram illustrating functions implemented in a CPLD;

FIG. 6 illustrates what is performed by CPLD;

FIG. 7 is a sequence diagram illustrating operation of the control module;

FIG. 8 is another sequence diagram illustrating operation of the control module;

FIG. 9 is a flowchart of a process executed by CPLD when configuring FPGA;

FIG. 10 illustrates a control module according to a third embodiment;

FIG. 11 is a block diagram illustrates functions implemented in CPLD according to the third embodiment;

FIG. 12 is a sequence diagram illustrating operation of the control module; and

FIG. 13 illustrates an example of a device which includes non-volatile storage media.

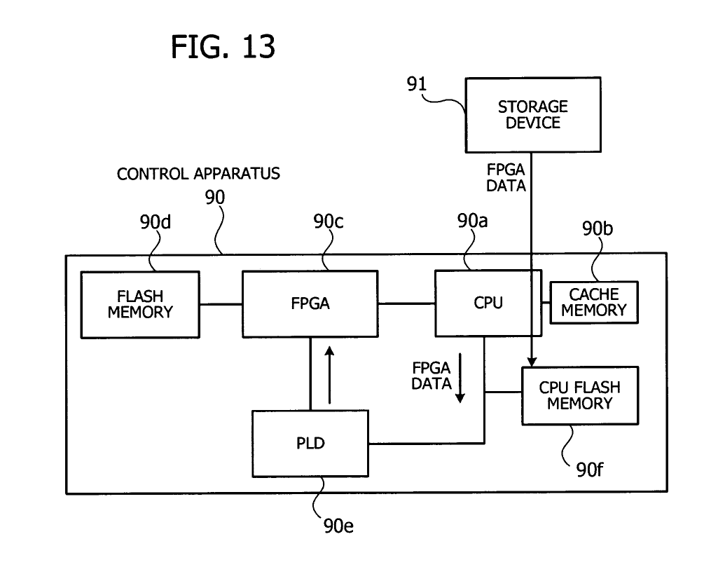

### DESCRIPTION OF EMBODIMENTS

Embodiments of the present invention will be described below with reference to the accompanying drawings, wherein like reference numerals refer to like elements throughout. The following description begins with an overview of a control apparatus according to a first embodiment and then proceeds to more specific embodiments.

### (a) First Embodiment

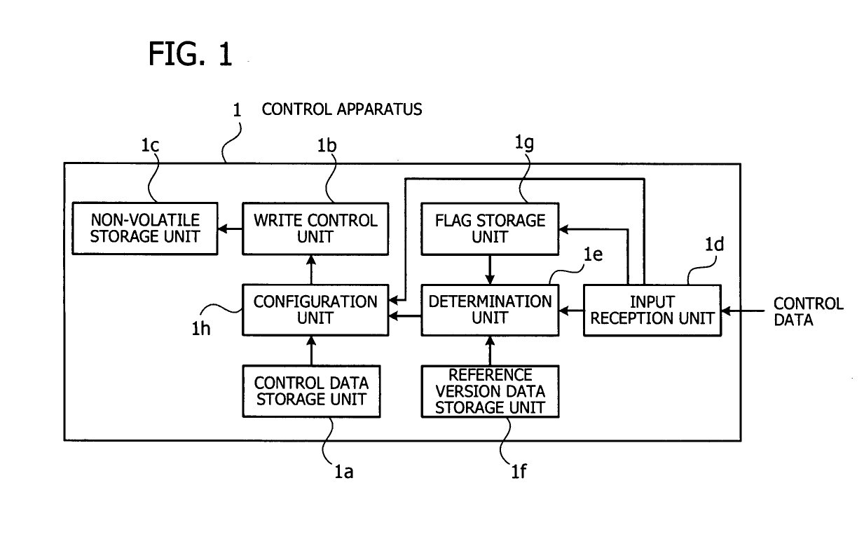

FIG. 1 gives an overview of a control apparatus according to a first embodiment. According to this first embodiment, the illustrated control apparatus 1 includes a control data storage unit 1a, a write control unit 1b, a non-volatile storage unit 1c, an input reception unit 1d, a determination unit 1e, a reference version data storage unit 1f, a flag storage unit 1g, and a configuration unit 1h.

The control data storage unit 1a stores control data that determines operation of the write control unit 1b. What this control data specifies may be, but not limited to, how the write control unit 1b is supposed to operate when the control apparatus 1 encounters power failure, as well as when the power recovers from failure.

As will be described below, the configuration unit 1h uses an appropriate set of control data to configure (or program) the write control unit 1b. The write control unit 1b is configurable with given control data; i.e., its operation is determined by given control data. The write control unit 1b controls data write operation to the non-volatile storage unit 1c.

For example, the write control unit 1b saves data from a volatile memory (not illustrated) of the control apparatus 1 to the non-volatile storage unit 1c when the control apparatus 1 has encountered power failure as mentioned earlier. When the power comes back to the control apparatus 1, the write control unit 1b restores the saved data from the non-volatile storage unit 1c back to the volatile memory.

The input reception unit 1d receives input of control data from an external source outside the control apparatus 1. Reception of such external control data is performed upon, for example (but not limited to), initial power-up of the control apparatus 1. The input reception unit 1d may also be designed to operate voluntarily to fetch control data from an external source outside the control apparatus 1. Further, the input reception unit 1d may have a temporary storage function to store received or fetched control data. Such temporary storage may be implemented by allocating an existing storage space or using some other storage medium (e.g., flash memory) not illustrated in FIG. 1. The input reception unit 1d may also receive flag setting information as will be described later.

The control data received by the input reception unit 1d may contain an identifier indicating the version of the data itself. The determination unit 1e compares this version identifier with a version identifier of existing control data in the reference version data storage unit 1f. This comparison of version identifiers indicates whether the received control data is newer than the control data stored in the control data storage unit 1a. For example, the reference version data storage unit 1f stores a version identifier of “A,” and the input reception unit 1d has received control data with a version identifier of “A” whereas the control data storage unit 1a stores control data with a version identifier of “B.” As “B” indicates a newer version than “A,” the determination unit 1e determines that the control data received by the input reception unit 1d is older than the control data stored in the control data storage unit 1a. It is noted that the determination unit 1e may be configured to compare the version identifier of received control data, not with that in the reference version data storage unit 1f, but with the version identifier of control data stored in the control data storage unit 1a.

The input reception unit 1d may also receive flag setting information, as mentioned above, in which case the input reception unit 1d sets a flag in the flag storage unit 1g according to that flag setting information. This flag is used by the determination unit 1e to determine whether to execute comparison of version identifiers. More specifically, the determination unit 1e tests the flag stored in the flag storage unit 1g, which is a part of the control apparatus 1 according to the present embodiment. If the flag is set, the determination unit 1e does not perform comparison of version identifiers. In other words, the determination unit 1e is allowed to compare the version identifier of the received control data with that of existing control data in the reference version data storage unit 1f unless the flag is set. Flag setting information is to be supplied to the input reception unit 1d together with control data when, for example, the control data includes a newer version identifier such as “C” (i.e., version C is newer than A and B).

The configuration unit 1h configures the write control unit 1b with either the control data received by the input reception unit 1d or the control data stored in the control data storage unit 1a, whichever is newer. Here the configuration unit 1h may be designed to configure the write control unit 1b with control data selected in accordance with the result of comparison performed by the determination unit 1e. Suppose, for example, that the control data received by the input reception unit 1d has the same version number as the control data stored in the control data storage unit 1a. In this case, the configuration unit 1h may decide not to configure the write control unit 1b with the control data stored in the control data storage unit 1a, thus preventing the same control data from being applied again to the write control unit 1b.

The configuration unit 1h may also be designed not to configure the write control unit 1b with the control data stored in the control data storage unit 1a in the case where the determination unit 1e is not supposed to execute comparison of versions (i.e., the above-noted flag is set). This feature makes it possible to prevent the configuration unit 1h from applying an old version of control data to the write control unit 1b even if it is stored in the control data storage unit 1a.

As can be seen from the above, the proposed control apparatus 1 configures its write control unit 1b with a newer version of control data, which is either the one received by the input reception unit 1d or the one stored in the control data storage unit 1a. This feature prevents the write control unit 1b from being configured with an old version of control data, thus avoiding consequent malfunctioning of the write control unit 1b.

The control data storage unit 1a may be implemented by using flash memory or other memory devices. The write control unit 1b may be implemented by using a field-programmable gate array (FPGA) or other programmable device. The input reception unit 1d may be implemented by using a central processing unit (CPU) or other processing device. Further, the input reception unit 1d, determination unit 1e, reference version data storage unit 1f, flag storage unit 1g, and configuration unit 1h may be implemented by using complex programmable logic devices (CPLD) or other programmable devices.

The reference version data storage unit 1f and flag storage unit 1g may be implemented as part of the control apparatus 1 or may be located somewhere else. It is also possible to eliminate the reference version data storage unit 1f and flag storage unit 1g. The next and subsequent sections will describe more specific embodiments.

### (b) Second Embodiment

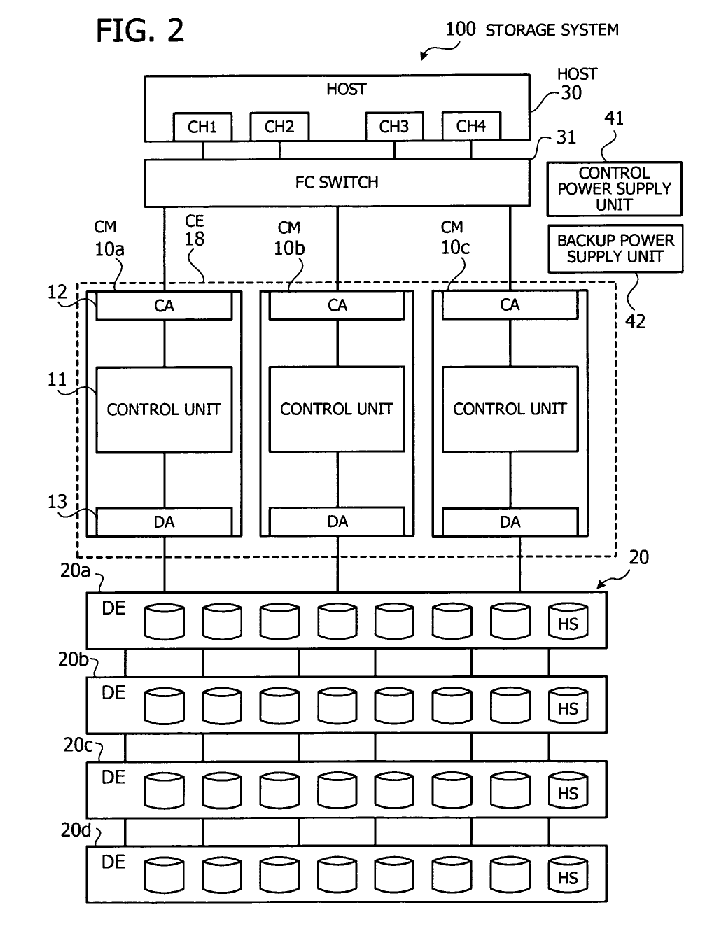

FIG. 2 is a block diagram illustrating a storage system according to a second embodiment. The illustrated storage system 100 is formed from a host computer (simply, “host”) 30, a plurality of controller modules (CM) 10a, 10b, and 10c for controlling operation of disks, and a plurality of drive enclosures (DE) 20a, 20b, 20c, and 20d which, as a whole, constitute a storage device 20. The drive enclosures 20a, 20b, 20c, and 20d are coupled to the host 30 via the control modules 10a, 10b, and 10c.

The storage system 100 has redundancy to increase reliability of operation. Specifically, the storage system 100 has two or more control modules. Those control modules 10a, 10b, and 10c are installed in a controller enclosure (CE) 18, each acting as a separate storage control device. The control modules 10a, 10b, and 10c can individually be attached to or detached from the controller enclosure 18. While FIG. 2 illustrates only one host 30, two or more such hosts may be linked to the controller enclosure 18.

Each control module 10a, 10b, and 10c sends I/O commands to drive enclosures 20a, 20b, 20c, and 20d to make access to data stored in storage space of storage drives. The control modules 10a, 10b, and 10c wait for a response from the drive enclosures 20a, 20b, 20c, and 20d, counting the time elapsed since their I/O command. Upon expiration of an access monitoring time, the control modules 10a, 10b, and 10c send an abort request command to the drive enclosures 20a, 20b, 20c, and 20d to abort the requested I/O operation. The storage device 20 is formed from those drive enclosures 20a, 20b, 20c, and 20d organized as Redundant Arrays of Inexpensive Disks (RAID) to provide functional redundancy.

The control module 10a includes a control unit 11 to control the module in its entirety. The control unit 11 is coupled to a channel adapter (CA) 12 and a device adapter (DA) 13 via an internal bus.

The channel adapter 12 is linked to a Fibre Channel (FC) switch 31. Via this Fibre Channel switch 31, the channel adapter 12 is further linked to channels CH1, CH2, CH3, and CH4 of the host 30, which allows the host 30 to exchange data with a CPU 11a (not illustrated in FIG. 2) in the control unit 11.

The device adapter 13, on the other hand, is linked to external drive enclosures 20a, 20b, 20c, and 20d constituting a storage device 20. The control unit 11 exchanges data with those drive enclosures 20a, 20b, 20c, and 20d via the device adapter 13.

The control power supply unit 41 is connected to the control modules 10a, 10b, and 10c to supply power for them. The backup power supply unit 42 is also connected to the control modules 10a, 10b and 10c. The backup power supply unit 42 contains capacitors (not illustrated) for backup purposes. When the control power supply unit 41 is working (i.e., when the control modules 10a, 10b and 10c are powered by the control power supply unit 41), the backup power supply unit 42 charges energy in its internal capacitors with the power provided from the control power supply unit 41.

When the power is lost (i.e., when the control power supply unit 41 stops supplying power to control modules 10a, 10b, and 10c due to, for example, power outages), the backup power supply unit 42 provides power stored in the internal capacitors to the control modules 10a, 10b, and 10c. With the power from those capacitors, the control modules 10a, 10b, and 10c save data from CPU cache (described later) to a NAND flash memory (described later) in the control unit 11.

The above hardware configuration of the control module 10a also applies to other control modules 10b and 10c. The described hardware serves as a platform for implementing processing functions of the control modules 10a, 10b, and 10c.

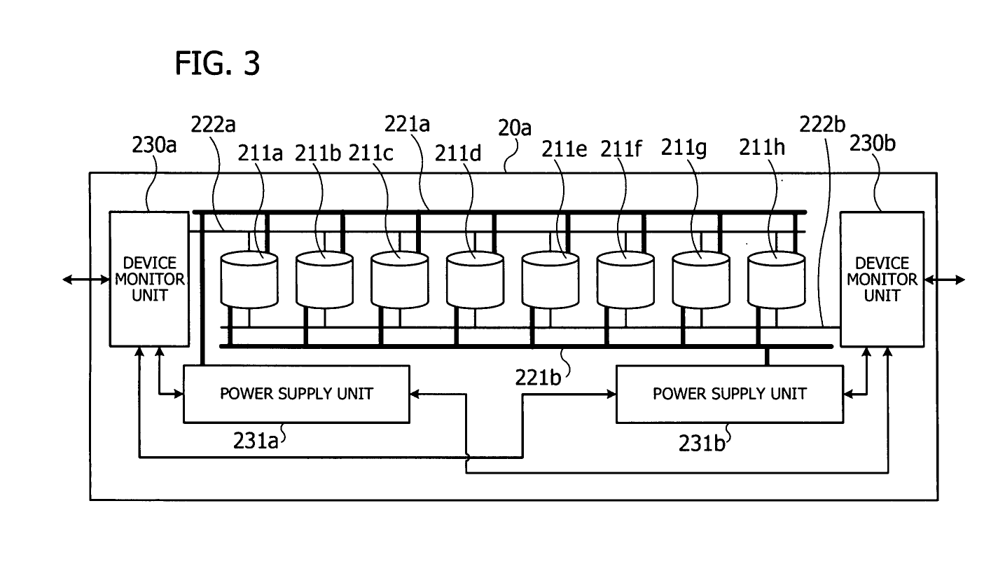

FIG. 3 illustrates an example of a drive enclosure. The illustrated drive enclosure 20a includes, among others, a plurality of storage drives 211a, 211b, 211c, 211d, 211e, 211f, 211g, and 211h to store data and a plurality of power supply units (PSU) 231a and 231b to supply power to each storage drive 211a to 211h via power lines 221a and 221b. The drive enclosure 20a also includes a plurality of device monitor units 230a and 230b, or port bypass circuits (PBC), coupled to each storage drive 211a to 211h via input-output paths 222a and 222b.

The storage drives 211a to 211h are configured to receive power from both power supply units 231a and 231b. Each of the two power supply units 231a and 231b has a sufficient power output to simultaneously drive all storage drives 211a to 211h in a single drive enclosure 20a, as well as to simultaneously start up a predetermined number of storage drives if not all of the storage drives 211a to 211h. Because of such redundant power supply units 231a and 231b, the storage drives 211a to 211h can continue their operation even if one of the power supply units 231a and 231b fails.

The device monitor units 230a and 230b read and write data in the storage drives 211a to 211h according to commands from the control modules 10a to 10c. The device monitor units 230a and 230b also monitor the operation of each storage drive 211a to 211h, thus identifying their operating states (e.g., working, started, stopped). The “working” state means that the device is in steady-state operation after successful startup. Data read and write operations are performed in this working state.

The device monitor units 230a and 230b further monitor the operation of each power supply unit 231a and 231b, thus detecting their operating modes and failure. The device monitor units 230a and 230b also observe the current load (i.e., current power consumption) on the power supply units 231a and 231b, besides identifying the maximum supply power that each power supply unit 231a and 231b can provide. While FIG. 3 illustrates only one drive enclosure 20a, the other drive enclosures 20b to 20d also have the same structure described above.

The storage device 20 is formed from the above-described drive enclosures 20b to 20d organized as RAID systems. For example, a plurality of storage drives in each drive enclosure 20b to 20d may be configured to store different portions of user data in a distributed way. The storage drives may also be configured to store the same user data in two different drives. The storage device 20 has a plurality of RAID groups formed from one or more storage drives in the drive enclosures 20a to 20d. Those RAID groups in the storage device 20 are assigned logical volumes. It is assumed here that the RAID groups are uniquely associated with different logical volumes. The embodiment, however, is not limited by this assumption, but may be configured to associate one logical volume with a plurality of RAID groups. It is also possible to associate one RAID group with a plurality of logical volumes. The embodiment is also not limited to the specific number of storage drives in the drive enclosure 20a illustrated in FIG. 3. More specifically, while FIG. 3 illustrates eight storage drives 211a to 211h per drive enclosure, the embodiment may be modified so as to include any other number of storage drives in a single drive enclosure. The next section will discuss in detail the functions of the control modules 10a, 10b, and 10c outlined above.

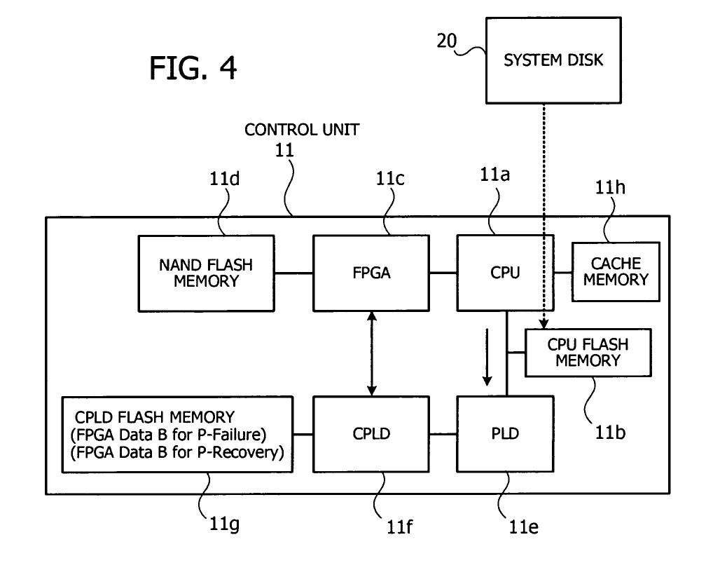

FIG. 4 is a block diagram illustrating functions of a control module. The illustrated control unit 11 is formed from a CPU 11a, a CPU flash memory 11b, a cache memory 11h, an FPGA 11c, a NAND flash memory 11d, a programmable logic device (PLD) 11e, a complex PLD (CPLD) 11f, and a CPLD flash memory 11g.

The CPU 11a controls the entire control unit 11. Specifically, the CPU 11a is coupled to the CPU flash memory 11b, FPGA 11c, and PLD 11e via an internal bus. The CPU 11a is also coupled to the cache memory 11h via its memory interface (not illustrated).

The storage device 20 stores firmware of the control module 10a in archived form. That is, the storage device 20 also serves as a storage device for control data. This firmware is read out of the storage device 20 and written into the CPU flash memory 11b when, for example, the control module 10a is installed in the storage system 100. The CPU 11a performs this firmware loading operation by automatically making access to where the firmware is stored in the storage device 20 or by doing so in accordance with a user command.

The firmware contains FPGA data that determines operation of the FPGA 11c. The firmware of the control module 10a is updated when it is necessary to revise FPGA data of the FPGA 11c. Suppose now that the version number of FPGA data is changed in the alphabetical order as in “A,” “B,” and “C” each time the FPGA data is revised. In this example notation, version A is the oldest, and version C is the newest.

Each single volume of firmware contains a single version of FPGA data. The version-C firmware is the only firmware that contains a function disable register setup request for setting a function disable register (described later). In other words, the firmware with a version number of A or B does not contain function disable register setup requests. The function disable register setup request contains information indicating the address of a function disable register, together with a request for setting that function disable register.

The FPGA 11c is supposed to provide at least two functions. One function is to save data from the cache memory 11h to the NAND flash memory 11d in the case of power failure. Another function is to restore the saved data from the NAND flash memory 11d back to the cache memory 11h in the case of power recovery. Two sets of FPGA data are thus provided; one is for use in power failure, and the other is for use in power recovery.

When the firmware retrieved from the storage device 20 contains a function disable register setup request, the CPU 11a sends that function disable register setup request to the CPLD 11f via the PLD 11e. The CPU 11a stores the retrieved firmware in the CPU flash memory 11b. When a need arises, the CPU 11a reads FPGA data out of this firmware in the CPU flash memory 11b and sends it to the CPLD 11f via the PLD 11e.

The CPU flash memory 11b is also used to temporarily store the whole or part of software programs that the CPU 11a executes. The CPU flash memory 11b further stores other various data objects that the CPU 11a manipulates, which include FPGA data read out of the storage device 20.

The FPGA 11c, when configured with FPGA data, controls the NAND flash memory 11d, which is coupled the FPGA 11c via an interface (not illustrated). Details of this control will be discussed later. The NAND flash memory 11d is a non-volatile storage device, the space of which is used to save data stored in the cache memory 11h in the case of power failure. The PLD 11e receives FPGA data from the CPU 11a and sends it to the CPLD 11f.

The CPLD flash memory 11g, coupled to the CPLD 11f, has previously been loaded with two sets of FPGA data with a version number of “B.” That is, one version-B FPGA data is for use in power failure, and the other version-B FPGA data is for use in power recovery. In FIG. 4, the former FPGA data is abbreviated as “FPGA Data B for P-Failure,” and the latter FPGA data is abbreviated as “FPGA Data B for P-Recovery.” The version-B FPGA data stored in the CPLD flash memory 11g is supposed to be able to control the NAND flash memory 11d when the FPGA 11c is configured with that data.

The CPLD 11f is coupled to the FPGA 11c, PLD 11e, and CPLD flash memory 11g. The CPLD 11f controls configuration, or programming, of the FPGA 11c, based on FPGA data stored in the CPU flash memory 11b and FPGA data stored in the CPLD flash memory 11g. The following section will describe in detail the functions of this CPLD 11f.

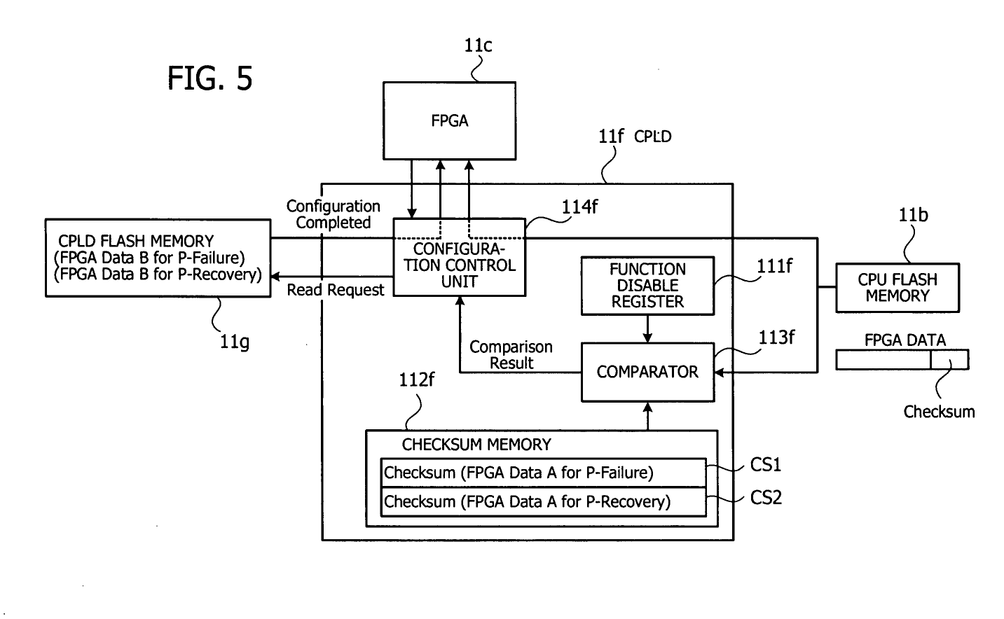

FIG. 5 is a block diagram illustrating functions implemented in the CPLD 11f. Specifically, the CPLD 11f includes a function disable register 111f, a checksum memory 112f, a comparator 113f, and a configuration control unit 114f. The function disable register 111f stores information that determines whether to make the comparator 113f operate. The function disable register 111f is initially set to OFF state, meaning that the comparator 113f is allowed to operate. The function disable register 111f is set to ON state by the CPLD 11f through the PLD 11e when a function disable register setup request is received from the CPU 11a. The ON state means that the comparator 113f is disabled.

The checksum memory 112f stores checksums CS1 and CS2 of FPGA data that the designer wishes to prevent from being loaded in the FPGA 11c for some reasons. For example, the designer may doubt that some particular version of FPGA data can work properly with the current FPGA 11c in its reading and writing the NAND flash memory 11d. In this case, the checksums of such FPGA data are set in the checksum memory 112f.

Those checksums CS1 and CS2 actually include additional information to identify the version and function of FPGA data. In the example of FIG. 5, the illustrated checksums CS1 and CS2 are of version-A FPGA data (“FPGA data A”), which is older than version-B FPGA data currently stored in the CPLD flash memory 11g. The following description assumes that the FPGA 11c may not operate correctly to read or write data in the NAND flash memory 11d if it is configured with the version-A FPGA data.

As mentioned previously, there are two sets of FPGA data to deal with both power failure and power recovery. Checksum CS1 is of FPGA data for use in power failure (“Checksum (FPGA Data A for P-Failure)” in FIG. 5), while checksum CS2 is of FPGA data for use in power recovery (“Checksum (FPGA Data A for P-Recovery)” in FIG. 5).

The comparator 113f determines whether to compare the function and version number of FPGA data read out of the CPU flash memory 11b with the function and version number “A” of FPGA data indicated in the checksums CS1 and CS2 stored in the checksum memory 112f. This determination depends on the state of the function disable register 111f. More specifically, the comparator 113f determines not to perform the above comparison if the function disable register 111f is set to ON state.

If, on the other hand, the function disable register 111f is in OFF state, the comparator 113f determines to perform the above comparison. That is, the comparator 113f compares the checksum of FPGA data read out of the CPU flash memory 11b with checksum CS1 in the checksum memory 112f. The comparator 113f also compares the checksum of FPGA data read out of the CPU flash memory 11b with checksum CS2 in the checksum memory 112f.

The comparator 113f then sends comparison results to the configuration control unit 114f. The comparison results indicate whether the FPGA data read out of the CPU flash memory 11b is newer or older than the version-A FPGA data indicated in the checksums CS1 and CS2. The comparison results also indicate whether the function of the FPGA data read out of the CPU flash memory 11b is for use in power failure or for use in power recovery.

The configuration control unit 114f configures the FPGA 11c with FPGA data when it is sent from the CPU 11a via PLD 11e for the configuration purpose. The configuration control unit 114f also receives comparison results from the comparator 113f. Based on the received comparison results, the configuration control unit 114f determines whether to reconfigure the FPGA 11c with FPGA data stored in the CPLD flash memory 11g. More specifically, if the comparison results indicate that the FPGA data read out of the CPU flash memory 11b is newer than the version-A FPGA data indicated in checksums CS1 and CS2 in the checksum memory 112f, the configuration control unit 114f determines not to execute reconfiguration of the FPGA 11c with the FPGA data stored in the CPLD flash memory 11g. When that is the case, the configuration control unit 114f issues no data request to the CPLD flash memory 11g since there is no need to read out the FPGA data stored therein.

The comparison results may indicate that the FPGA data read out of the CPU flash memory 11b has the same version number as the version-A FPGA data indicated in checksums CS1 and CS2 in the checksum memory 112f. In this case, the configuration control unit 114f determines to execute reconfiguration of the FPGA 11c with the FPGA data stored in the CPLD flash memory 11g. The configuration control unit 114f then consults the comparison results again to determine whether the FPGA data read out of the CPU flash memory 11b is for use in power failure or for use in power recovery.

If the FPGA data is found to be for power failure, the configuration control unit 114f sends the CPLD flash memory 11g a request for reading FPGA data for use in power failure. Or, if the FPGA data is found to be for power recovery, the configuration control unit 114f sends the CPLD flash memory 11g a request for reading FPGA data for use in power recovery. The configuration control unit 114f then configures the FPGA 11c with the FPGA data that the CPLD flash memory 11g provides for the purpose of reconfiguration.

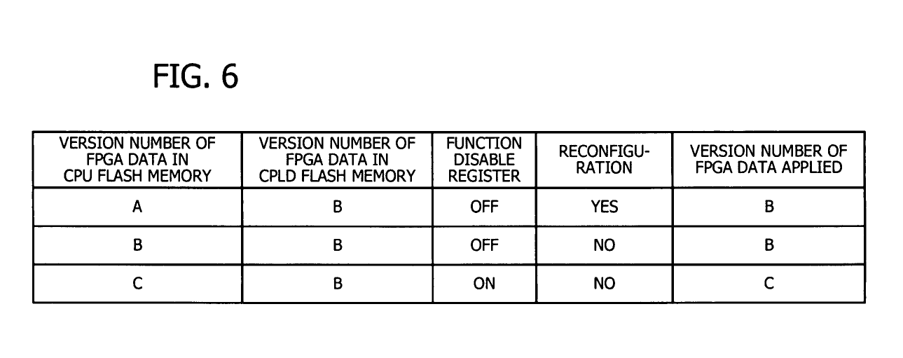

The above-described actions of the comparator 113f and configuration control unit 114f can be summarized in tabular form. Specifically, FIG. 6 illustrates what is performed by CPLD.

When FPGA data stored in the CPU flash memory 11b is of version A (i.e., the firmware that the CPU 11a has retrieved from the storage device 20 contains FPGA data with a version number of “A”), the function disable register 111f stays in the OFF state since the CPU 11a sends no function disable register setup requests to the CPLD 11f. Since the function disable register 111f is OFF, the comparator 113f executes a comparison of FPGA data, and the configuration control unit 114f reconfigures the FPGA 11c according to comparison results of the comparator 113f. As an overall result, FPGA data with a version number of B is applied to the FPGA 11c.

In the case where the FPGA data stored in the CPU flash memory 11b is of version B (i.e., the firmware that the CPU 11a has retrieved from the storage device 20 contains FPGA data with a version number of “B”), the function disable register 111f stays in the OFF state since the CPU 11a sends no function disable register setup requests to the CPLD 11f via the PLD 11e. Since the function disable register 111f is OFF, the comparator 113f executes a comparison of FPGA data. The comparison results of the comparator 113f disable the configuration control unit 114f from performing reconfiguration of the FPGA 11c. As an overall result, FPGA data with a version number of B is applied to the FPGA 11c.

In the case where the FPGA data stored in the CPU flash memory 11b is of version C (i.e., the firmware that the CPU 11a has retrieved from the storage device 20 contains FPGA data with a version number of “C”), the CPU 11a sends a function disable register setup request to the CPLD 11f via the PLD 11e. The function disable register 111f is thus set to ON state, which prevents the comparator 113f from executing comparison of FPGA data. Since no comparison results are available from the comparator 113f, the configuration control unit 114f does not perform reconfiguration of the FPGA 11c. As an overall result, FPGA data with a version number of C is applied to the FPGA 11c.

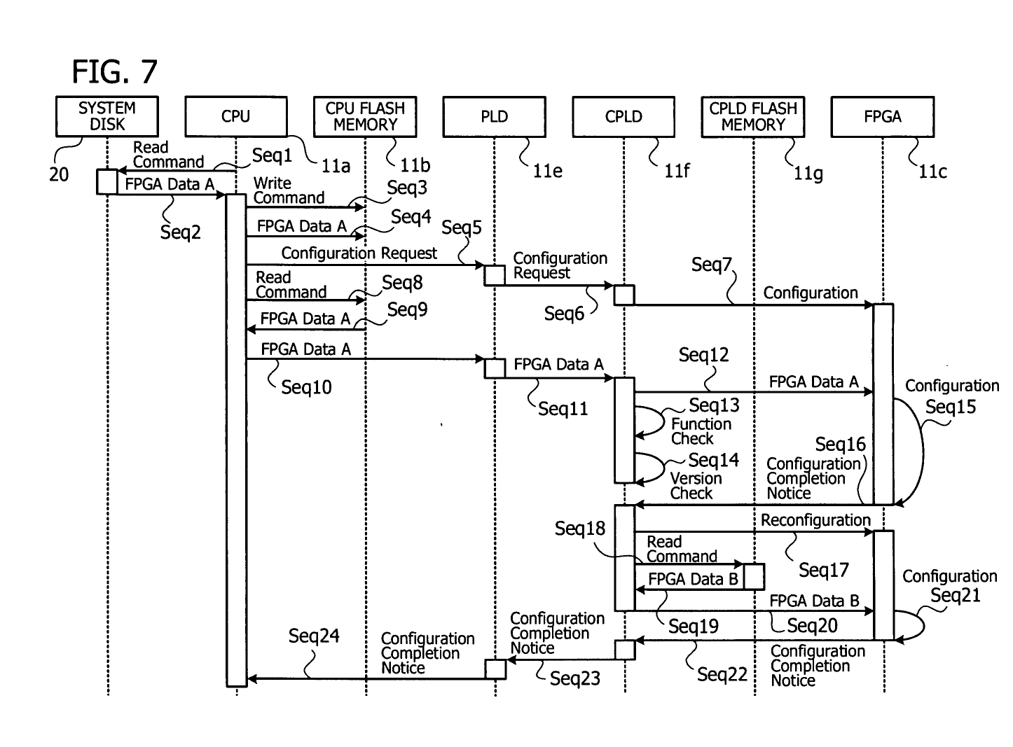

Referring to FIG. 7, the next section will describe an example of how the control module 10a operates when it is installed into the storage system 100, assuming that the control module 10a has FPGA data with a version number of B in its CPLD flash memory 11g. It is also assumed that when the control module 10a is installed, its CPU 11a reads firmware out of the storage device 20 which includes FPGA data with a version number of “A.”

FIG. 7 is a sequence diagram illustrating operation of the control module. In FIG. 7, “FPGA data A” refers to FPGA data with a version numbers of A. Similarly, “FPGA data B” refers to FPGA data with a version numbers of B. The following will provide a brief description of each step of the illustrated sequence in the order of sequence numbers.

(Seq1) The CPU 11a sends a read command to the storage device (system disk) 20 to read out firmware.

(Seq2) Upon receipt of the above firmware read command, the storage device 20 provides the CPU 11a with firmware containing version-A FPGA data.

(Seq3) The CPU 11a sends a write command to the CPU flash memory 11b to write the retrieved firmware.

(Seq4) Subsequent to the write command, the CPU 11a supplies the CPU flash memory 11b with the firmware containing version-A FPGA data.

(Seq5) The CPU 11a sends a configuration request to the PLD 11e.

(Seq6) The PLD 11e forwards the received configuration request to the CPLD 11f.

(Seq7) Upon receipt of the configuration request, the CPLD 11f executes configuration of the FPGA 11c. The FPGA 11c initializes its configuration memory and makes other preparations, thus getting ready for receiving FPGA data for its configuration.

(Seq8) The CPU 11a sends the CPU flash memory 11b a read command for FPGA data.

(Seq9) In response to the read command, the CPU flash memory 11b outputs version-A FPGA data to the CPU 11a.

(Seq10) The CPU 11a forwards the received version-A FPGA data to the PLD 11e.

(Seq11) The PLD 11e forwards the received version-A FPGA data to the CPLD 11f.

(Seq12) The CPLD 11f forwards the received version-A FPGA data to the FPGA 11c.

(Seq13) The comparator 113f determines whether to compare the function and version number of the FPGA data received at Seq11 with the function and version number “A” of FPGA data indicated in checksums CS1 and CS2 stored in the checksum memory 112f. This determination depends on the state of the function disable register 111f.

The function disable register 111f remains in the OFF state since none of the above actions at Seq1 to Seq12 turns it on. Accordingly, the comparator 113f compares the function of the FPGA data received at Seq11 with that of FPGA data indicated in the checksums CS1 and CS2 stored in the checksum memory 112f. This comparison permits the comparator 113f to determine whether the FPGA data received at Seq11 is for use in power failure or for use in power recovery.

(Seq14) The comparator 113f compares the version number “A” of the FPGA data received at Seq11 with the version number “A” of FPGA data indicated in the checksums CS1 and CS2. Since the two sets of FPGA data have the same version number, the comparator 113f decides to execute reconfiguration.

(Seq15) The FPGA 11c starts configuration with the version-A FPGA data received at Seq12, upon detection of its preamble (topmost data). Preferably the above actions of Seq13 to Seq15 are executed in parallel since parallel execution reduces the time to finish the process of FIG. 7.

(Seq16) The FPGA 11c sends a configuration completion notice to the CPLD 11f to indicate that the configuration is completed.

(Seq17) Upon receipt of the configuration completion notice, the CPLD 11f initiates reconfiguration of the FPGA 11c. The FPGA 11c initializes its configuration memory and makes other preparations, thus being ready for receiving FPGA data for reconfiguration.

(Seq18) According to the decision made at Seq14 to execute reconfiguration, the CPLD 11f sends a read command to the CPLD flash memory 11g to read out version-B FPGA data that provides the function identified at Seq13.

(Seq19) Upon receipt of the read command, the CPLD flash memory 11g sends the specified version-B FPGA data back to the CPLD 11f.

(Seq20) The CPLD 11f passes the received version-B FPGA data to the FPGA 11c.

(Seq21) The FPGA 11c starts configuration with the version-B FPGA data received at Seq20, upon detection of its preamble.

(Seq22) The FPGA 11c sends a configuration completion notice to the CPLD 11f to indicate that the configuration is completed.

(Seq23) The CPLD 11f forwards the received configuration completion notice to the PLD 11e.

(Seq24) The PLD 11e forwards the received configuration completion notice to the CPU 11a. The sequence of FIG. 7 is thus finished.

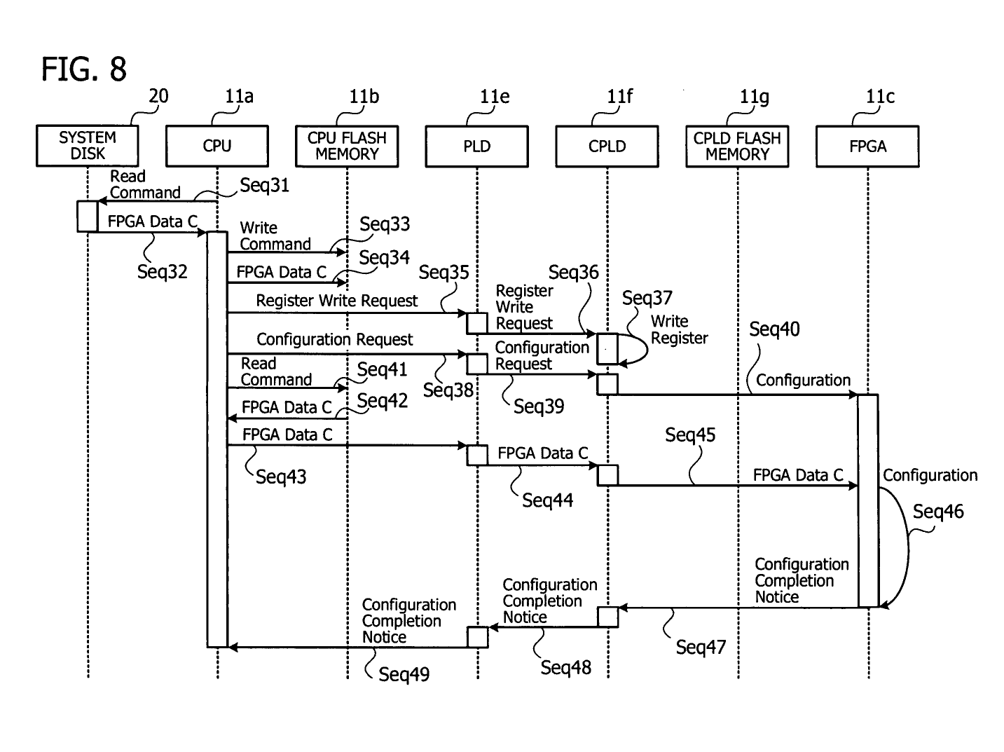

Referring now to FIG. 8, the next section will describe another example of how the control module 10a operates when it is installed into the storage system 100, assuming that the control module 10a has FPGA data with a version number of B in its CPLD flash memory 11g. It is also assumed that when the control module 10a is installed, its CPU 11a reads firmware out of the storage device 20 which includes FPGA data with a version number of “C.”

FIG. 8 is another sequence diagram illustrating operation of the control module, in which “FPGA data A” to refer to FPGA data with a version numbers of A. The following will provide a brief description of each step of the illustrated sequence in the order of sequence numbers.

(Seq31) The CPU 11a sends a read command to the storage device (system disk) 20 to read out firmware.

(Seq32) Upon receipt of the above firmware read command, the storage device 20 provides the CPU 11a with firmware containing version-C FPGA data.

(Seq33) The CPU 11a sends a write command to the CPU flash memory 11b to write the retrieved firmware.

(Seq34) Subsequent to the write command, the CPU 11a supplies the CPU flash memory 11b with the firmware containing version-C FPGA data.

(Seq35) The firmware provided to the CPU 11a at Seq32 includes a register write request. The CPU 11a outputs this register write request to the PLD 11e.

(Seq36) The PLD 11e forwards the received register write request to the CPLD 11f.

(Seq37) Upon receipt of the register write request, the CPLD 11f sets the function disable register 111f to the ON state.

(Seq38) The CPU 11a issues a configuration request to the PLD 11e.

(Seq39) The PLD 11e forwards the received configuration request to the CPLD 11f.

(Seq40) Upon receipt of the configuration request, the CPLD 11f executes configuration of the FPGA 11c. The FPGA 11c initializes its configuration memory and makes other preparations, thus getting ready for receiving FPGA data for configuration.

(Seq41) The CPU 11a sends the CPU flash memory 11b a read command for FPGA data.

(Seq42) In response to the read command, the CPU flash memory 11b outputs version-C FPGA data to the CPU 11a.

(Seq43) The CPU 11a supplies the received version-C FPGA data to the PLD 11e.

(Seq44) The PLD 11e forwards the received version-C FPGA data to the CPLD 11f.

(Seq45) The CPLD 11f forwards the received version-C FPGA data to the FPGA 11c. The comparator 113f in the CPLD 11f does not perform comparison of functions or versions of FPGA data since the function disable register 111f has been turned on at Seq37.

(Seq46) The FPGA 11c starts configuration with the version-C FPGA data received at Seq45, upon detection of its preamble.

(Seq47) The FPGA 11c sends a configuration completion notice to the CPLD 11f to indicate that the configuration is completed.

(Seq48) The CPLD 11f forwards the received configuration completion notice to the PLD 11e.

(Seq49) The PLD 11e forwards the received configuration completion notice to the CPU 11a. The sequence of FIG. 8 is thus finished.

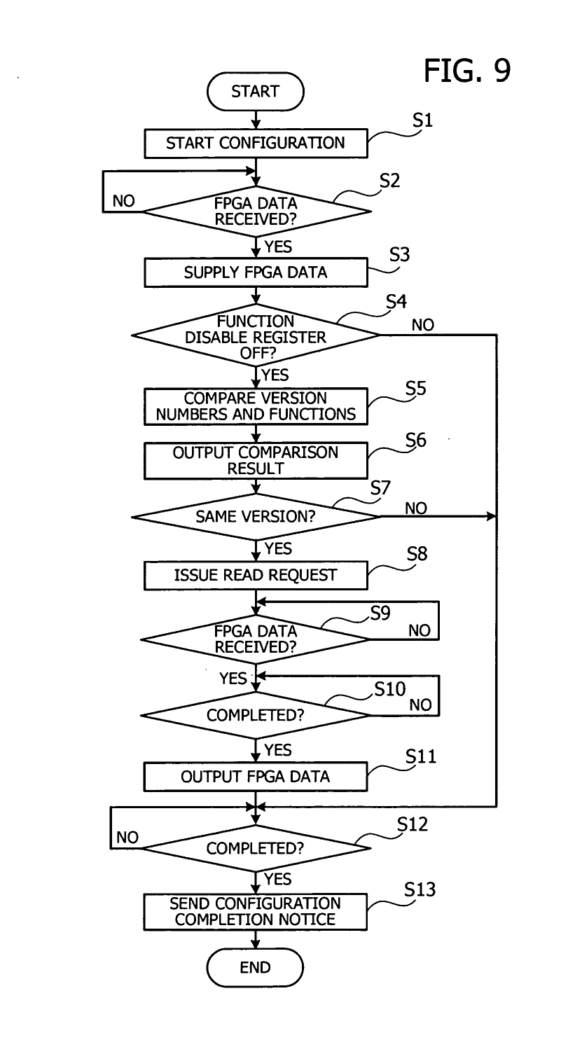

Referring next to the flowchart of FIG. 9, the following section will describe how the CPLD operates during FPGA configuration. A brief description of each step of the flowchart will be provided in the order of step numbers.

(Step S1) Upon receipt of a configuration request from the PLD 11e, the configuration control unit 114f starts configuration of the FPGA 11c. The process then moves to step S2.

(Step S2) The configuration control unit 114f determines whether FPGA data has been received from the PLD 11e. If FPGA data has been received (Yes at step S2), the process advances to step S3. If FPGA data has not been received (No at step S2), the configuration control unit 114f waits for it.

(Step S3) The configuration control unit 114f supplies the received FPGA data to the FPGA 11c. The process then proceeds to step S4.

(Step S4) The comparator 113f determines whether the function disable register 111f is in the OFF state. If the function disable register 111f is in the OFF state (Yes at step S4), the process advances to step S5. If the function disable register 111f is in the ON state (No at step S4), the process skips to step S12.

(Step S5) The comparator 113f compares the function and version number of the FPGA data received from the PLD 11e with the function and version number “A” of FPGA data indicated in checksums CS1 and CS2 stored in the checksum memory 112f. The process then proceeds to step S6.

(Step S6) The comparator 113f sends results of the comparison at step S5 to the configuration control unit 114f. The process then proceeds to step S7.

(Step S7) Upon receipt of comparison results, the configuration control unit 114f determines whether the FPGA data received from the PLD 11e has the same version number “A” indicated in the checksums CS1 and CS2. If the version numbers match with each other (Yes at step S7), the process advances to step S8. If the version numbers do not match (No at step S7), i.e., if the FPGA data received from the PLD 11e has a newer version number than “A” in the checksums CS1 and CS2, the process skips to step S12.

(Step S8) The configuration control unit 114f issues a read request to the CPLD flash memory 11g to retrieve FPGA data that matches with the function compared at step S5. The process then proceeds to step S8.

(Step S9) The configuration control unit 114f determines whether FPGA data for reconfiguration has been received from the CPLD flash memory 11g. If FPGA data for reconfiguration has been received (Yes at step S9), the process advances to step S10. If no such FPGA data is received (No at step S9), the configuration control unit 114f waits for it.

(Step S10) The configuration control unit 114f determines whether a configuration completion notice has been received from the FPGA 11c. If a configuration completion notice has been received (Yes at step S10), the process advances to step S11. If no configuration completion notice is received (No at step S10), the configuration control unit 114f waits for it.

(Step S11) The configuration control unit 114f supplies the FPGA 11c with the FPGA data received at step S9. The process then proceeds to step S12.

(Step S12) The configuration control unit 114f determines whether a configuration completion notice has been received from the FPGA 11c. If a configuration completion notice has been received (Yes at step S12), the process advances to step S13. If no configuration completion notice is received (No at step S12), the configuration control unit 114f waits for it.

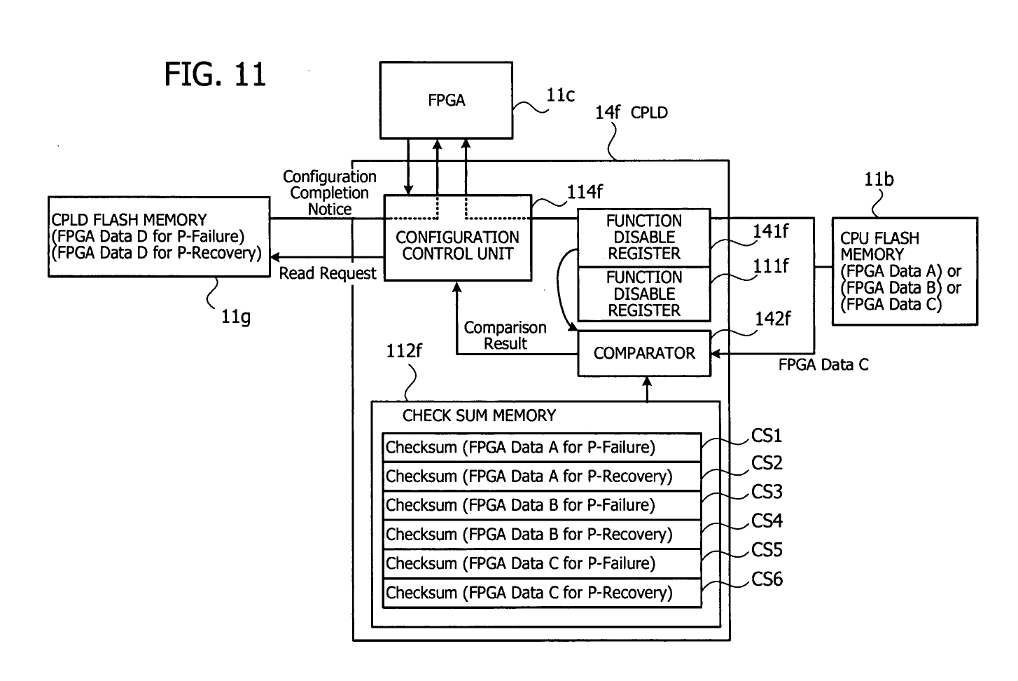

(Step S13) The configuration control unit 114f supplies the received configuration completion notice to the PLD 11e. The process of FIG. 11 is thus finished.

As can be seen from the above, the proposed storage system 100 is designed to reconfigure the FPGA with FPGA data stored in the CPLD flash memory 11g when the function disable register 111f is in OFF state, after the configuration control unit 114f configures the FPGA with FPGA data in the CPU flash memory 11b. The reconfiguration prevents the FPGA 11c from being programmed with an older version of FPGA data. This means that the NAND flash memory 11d can always be controlled properly by the FPGA 11c even if it is a new memory device. It is thus possible to ensure correct operation of the control module 10a. In addition, the second embodiment eliminates the need for human intervention in configuring FPGA 11c with new FPGA data, thus avoiding any potential problems related to human intervention.

When, on the other hand, the function disable register 111f is in ON state, the second embodiment configures FPGA only with FPGA data stored in the CPU flash memory 11b, but does not reconfigure the same with FPGA data stored in the CPLD flash memory 11g. More specifically, the FPGA data stored in the CPU flash memory 11b may have a newer version number than its counterpart in the CPLD flash memory 11g. In this case, the FPGA 11c is finally configured with the newer FPGA data, without undergoing reconfiguration. The second embodiment thus facilitates updating the function of FPGA to a new version.

The above-described second embodiment is designed to disable its comparator 113f and thereby skip comparison of version numbers and functions when the function disable register 111f is set to ON. The embodiment is not limited by this specific example, but the comparator 113f may be configured not to send its comparison results to the configuration control unit 114f even if the comparison of version numbers and functions is executed.

The check checksum memory 112f in the above-described second embodiment stores checksums CS1 and CS2 of version-A FPGA data, so that the comparator 113f compares the version number of FPGA data read out of the CPU flash memory 11b with version number “A” indicated in those checksums CS1 and CS2. The embodiment is not limited to that specific example, but may be modified such that the checksum memory 112f stores checksums of FPGA data stored in the CPLD flash memory 11g. In that case, the checksums CS1 and CS2 in the checksum memory 112f represent the version-B FPGA data. The comparator 113f then compares the version number of FPGA data read out of the CPU flash memory 11b with the version number B indicated in such checksums CS1 and CS2.

The above-described second embodiment does not apply version-C FPGA data to the FPGA 11c until it is configured with version-B FPGA data. The embodiment is not limited by this specific example, but may be modified to initiate configuration of the FPGA 11c with version-C FPGA data without waiting completion of configuration with version-B FPGA data.

### (c) Third Embodiment

This section describes a storage system 100 according to a third embodiment. The storage system 100 of the third embodiment shares several features with the foregoing storage system of the second embodiment. The description will focus on their differences and not repeat explanation of similar features.

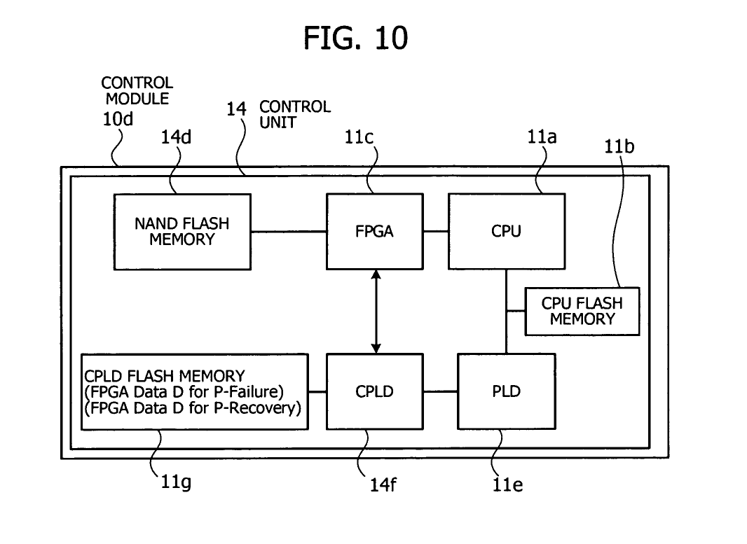

The third embodiment is different from the second embodiment in the structure of control modules in the storage system 100. FIG. 10 illustrates a control module according to the third embodiment. According to the third embodiment, the illustrated control module 10d is used in place of the control module 10a. It is noted that FIG. 10 omits some components in the control module 10d, other than those constituting its control unit 14. The following section uses the same reference numerals to refer to the same elements of the control unit 11 discussed in the second embodiment, and does not repeat their description.

The control unit 14 in the illustrated control module 10d has a NAND flash memory 14d which needs a control method that is different from that for the foregoing NAND flash memory 11d of the second embodiment. Correct control operation on this NAND flash memory 14d is achieved (i.e., data read and write operations are ensured) only when the FPGA 11c is configured with either version-D FPGA data for use in power failure (“FPGA data D for P-Failure” in FIG. 10) or version-D FPGA data for use in power recovery (“FPGA data D for P-Recovery” in FIG. 10), which are both stored in the CPLD flash memory 11g. In other words, the NAND flash memory 14d cannot be controlled correctly (i.e., data read and write operations cannot be ensured) by the FPGA 11c configured with FPGA data whose version is A or B or C.

The control unit 14 also has a CPLD 14f whose functions are different from the CPLD 11f discussed in the second embodiment. FIG. 11 is a block diagram illustrates functions implemented in CPLD according to the third embodiment. The following section uses the same reference numerals to refer to the same elements of the CPLD 11f discussed in the second embodiment, and does not repeat their description.

The CPU flash memory 11b contains FPGA data with a version number of A or B or C. The CPLD 14f contains, among others, a function disable register 141f storing information that determines whether to make a comparator 142f operate. This function disable register 141f is initially set to OFF state, meaning that the comparator 142f is allowed to operate.

According to the present embodiment, the checksum memory 112f contains the following information in addition to the foregoing checksums CS1 and CS2: checksum CS3 of version-B FPGA data for use in power failure (“Checksum (FPGA data B for P-Failure)” in FIG. 11), checksum CS4 of version-B FPGA data for use in power recovery (“Checksum (FPGA data B for P-Recovery)” in FIG. 11), checksum CS5 of version-C FPGA data for use in power failure (“Checksum (FPGA data C for P-Failure)” in FIG. 11), and checksum CS6 of version-C FPGA data for use in power recovery (“Checksum (FPGA data C for P-Recovery)” in FIG. 11).

Suppose now that the CPLD flash memory 11g stores FPGA data with a version number of “D.” When the CPU 11a retrieves its firmware containing version-C FPGA data from a storage device 20 (not illustrated), the control module 10a operates as follows:

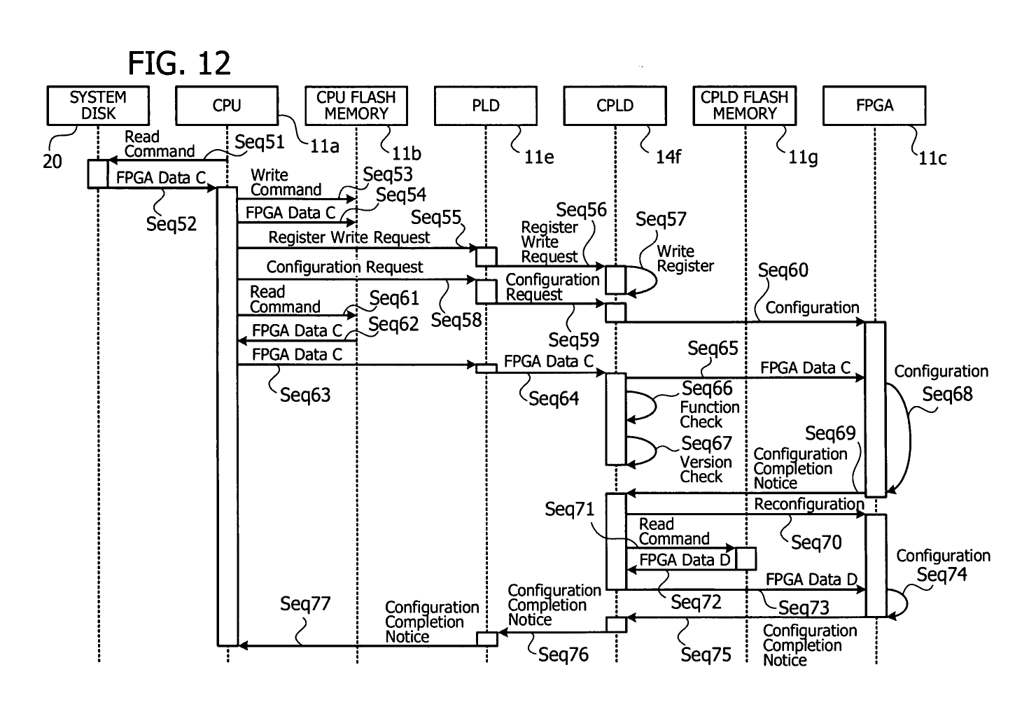

FIG. 12 is a sequence diagram illustrating operation of the control module 10a. In FIG. 12, “FPGA data C” to refer to FPGA data with a version numbers of C. Similarly, “FPGA data D” refers to FPGA data with a version numbers of D. The following will provide a brief description of each step of the illustrated sequence in the order of sequence numbers.

(Seq51) When maintenance work is finished, the CPU 11a sends a read command to the storage device (system disk) 20 to retrieve its firmware.

(Seq52) Upon receipt of the above firmware read command, the storage device 20 provides the CPU 11a with firmware containing version-C FPGA data.

(Seq53) The CPU 11a sends a write command to the CPU flash memory 11b to write the retrieved firmware.

(Seq54) Subsequent to the write command, the CPU 11a supplies the CPU flash memory 11b with the firmware containing version-C FPGA data.

(Seq55) The firmware provided to the CPU 11a at Seq52 includes a register write request. The CPU 11a outputs this register write request to the PLD 11e.

(Seq56) The PLD 11e forwards the received register write request to the CPLD 14f.

(Seq57) Upon receipt of the register write request, the CPLD 14f sets the function disable register 111f to the ON state.

(Seq58) The CPU 11a sends a configuration request to the PLD 11e.

(Seq59) The PLD 11e forwards the received configuration request to the CPLD 14f.

(Seq60) Upon receipt of the configuration request, the CPLD 14f executes configuration of the FPGA 11c. The FPGA 11c initializes its configuration memory and makes other preparations, thus getting ready for receiving FPGA data for configuration.

(Seq61) The CPU 11a sends the CPU flash memory 11b a read command for FPGA data.

(Seq62) In response to the read command, the CPU flash memory 11b outputs version-C FPGA data to the CPU 11a.

(Seq63) The CPU 11a supplies the received version-C FPGA data to the PLD 11e.

(Seq64) The PLD 11e forwards the received version-C FPGA data to the CPLD 14f.

(Seq65) The CPLD 14f forwards the received version-C FPGA data to the FPGA 11c.

(Seq66) Inside the CPLD 14f, the comparator 142f determines whether to compare the function and version number of the FPGA data received at Seq64 with the function and version number of FPGA data indicated in checksums CS1 to CS6 stored in the checksum memory 112f. This determination depends on the state of the function disable register 141f. It is noted here that one function disable register 141f remains in OFF state, whereas another function disable register 111f is set to ON state as a result of processing at Seq57. Accordingly, the comparator 142f compares the function of the FPGA data received at Seq64 with that of FPGA data indicated in checksums CS1 and CS6 stored in the checksum memory 112f. This comparison permits the comparator 142f to determine whether the version-C FPGA data received at Seq64 is for use in power failure or for use in power recovery.

(Seq67) The comparator 142f in the CPLD 14f compares the version number C of the FPGA data received at Seq64 with version numbers A, B, and C of the FPGA data indicated in checksums CS1 to CS6. The comparator 142f recognizes that the version number C of the FPGA data received at Seq64 matches with version number C indicated in checksums CS5 and CS6. Thus the configuration control unit 114f determines to execute reconfiguration.

(Seq68) The FPGA 11c starts configuration with the version-C FPGA data received at Seq64, upon detection of its preamble. Preferably the above actions of Seq66 to Seq68 are executed in parallel since parallel execution reduces the time to finish the process of FIG. 12.

(Seq69) The FPGA 11c sends a configuration completion notice to the CPLD 14f to indicate that the configuration is completed.

(Seq70) Upon receipt of the configuration completion notice, the CPLD 14f executes reconfiguration of the FPGA 11c. The FPGA 11c initializes its configuration memory and makes other preparations, thus getting ready for receiving FPGA data for configuration.

(Seq71) According to the decision made at Seq67 to execute reconfiguration, the CPLD 14f sends a read command to the CPLD flash memory 11g to read out version-D FPGA data that provides the function identified at Seq66.

(Seq72) Upon receipt of the read command, the CPLD flash memory 11g sends the specified version-D FPGA data to the CPLD 14f.

(Seq73) The CPLD 14f passes the received version-D FPGA data to the FPGA 11c.

(Seq74) Upon receipt of version-D FPGA data, the FPGA 11c executes configuration.

(Seq75) The FPGA 11c sends a configuration completion notice to the CPLD 14f to indicate that the configuration is completed.

(Seq76) The CPLD 14f forwards the received configuration completion notice to the PLD 11e.

(Seq77) The PLD 11e forwards the received configuration completion notice to the CPU 11a. The sequence of FIG. 12 is thus finished.

The storage system 100 of the third embodiment described above offers the same effects and advantages that the storage system 100 of the second embodiment offers. The storage system 100 of the third embodiment further prevents the FPGA 11c from being configured with version-C FPGA data even if the control module 10a is replaced with another control module 10d. That is, the third embodiment prevents the control module 10d from malfunctioning.

The above sections have exemplified several embodiments and their variations of the proposed control apparatus, control method, and storage system. The described components may be replaced with other components having equivalent functions or may include other components or processing operations. Where appropriate, two or more components and features provided in the embodiments may be combined in a different way.

The above-described processing functions may be implemented on a computer system. To achieve this implementation, the instructions describing the functions of control modules 10a, 10b, 10c, and 10d are encoded and provided in the form of computer programs. A computer system executes those programs to provide the processing functions discussed in the preceding sections. The programs may be encoded in a computer-readable, non-transitory medium for the purpose of storage and distribution. Such computer-readable media include magnetic storage devices, optical discs, magneto-optical storage media, semiconductor memory devices, and other tangible storage media. Magnetic storage devices include hard disk drives (HDD), flexible disks (FD), and magnetic tapes, for example. Optical disc media include DVD, DVD-RAM, CD-ROM, CD-RW and others. Magneto-optical storage media include magneto-optical discs (MO), for example.

Portable storage media, such as DVD and CD-ROM, are used for distribution of program products. Network-based distribution of software programs may also be possible, in which case several master program files are made available on a server computer for downloading to other computers via a network.

A computer stores necessary software components in its local storage unit, which have previously been installed from a portable storage medium or downloaded from a server computer. The computer executes programs read out of the local storage unit, thereby performing the programmed functions. Where appropriate, the computer may execute program codes read out of a portable storage medium, without installing them in its local storage device. Another alternative method is that the computer dynamically downloads programs from a server computer when they are demanded and executes them upon delivery.

The processing functions discussed in the preceding sections may also be implemented wholly or partly by using a digital signal processor. (DSP), application-specific integrated circuit (ASIC), programmable logic device (PLD), or other electronic circuit.

Various embodiments have been discussed above. The proposed control apparatus prevents itself from malfunctioning due to incorrect versions of FPGA data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A control apparatus comprising:
a non-volatile storage unit to store data;
a write control unit, configurable with given control data, to control operation of writing data to the non-volatile storage unit;
a control data storage unit to store first control data for the write control unit;
an input reception unit to receive second control data for the write control unit from an external source; and
a configuration unit to configure the write control unit with the first control data stored in the control data storage unit when the first control data has a newer version number than that of the second control data received by the input reception unit, and with the second control data when the second control data has a newer version number than that of the first control data.

2. The control apparatus according to claim 1, further comprising a determination unit to determine whether the version number of the second control data is newer than the version number of the first control data,
wherein the configuration unit configures the write control unit with the first control data stored in the control data storage unit according to a determination result of the determination unit.

3. The control apparatus according to claim 2, further comprising a flag storage unit to store a flag indicating whether the first control data stored in the control data storage unit is to be used to configure the write control unit,
wherein the determination unit determines whether to compare the version numbers of the first and second control data, depending on the flag stored in the flag storage unit.

4. The control apparatus according to claim 3, wherein the determination unit compares the version numbers only when the flag stored in the flag storage unit indicates that the first control data stored in the control data storage unit is to be used to configure the write control unit.

5. The control apparatus according to claim 3, wherein:
the flag in the flag storage unit is provided in a plurality, each corresponding to a different version of the first control data, and
the determination unit determines whether to compare the version numbers of the first and second control data, depending on the flags corresponding to different versions of the first control data.

6. The control apparatus according to claim 2, wherein the configuration unit starts configuring the write control unit with the second control data right after the second control data is received by the input reception unit, and configures later the write control unit with the first control data stored in the control data storage unit, depending on the determination made by the determination unit.

7. The control apparatus according to claim 2, wherein the configuration unit configures the write control unit with the second control data, concurrently with the determination by the determination unit.

8. The control apparatus according to claim 2, wherein the configuration unit does not use the first control data stored in the control data storage unit to configure the write control unit when the first control data has the same version number as the second control data received by the input reception unit.

9. The control apparatus according to claim 2, wherein the configuration unit configures the write control unit with the first control data whose function matches with that of the second control data received by the input reception unit.

10. A control method for providing control data that determines how a write control unit operates to control operation of writing data to a non-volatile memory, the control method comprising:
storing first control data for the write control unit in a control data storage unit;
receiving second control data for the write control unit from an external source; and
configuring the write control unit with the first control data stored in the control data memory when the first control data has a newer version number than that of the second control data received by the input reception unit, and with the second control data when the second control data has a newer version number than that of the first control data.

11. A storage system comprising:
a storage device to store data;
a control unit to control data storage operation on the storage device; and
a control data storage device to store second control data for controlling the control unit,
wherein the control unit comprises:
a non-volatile storage unit to which data is to be written,
a write control unit, configurable with given control data, to control operation of writing data to the non-volatile storage unit,
a control data storage unit to store first control data for the write control unit;
an input reception unit to receive the second control data for the write control unit from the control data storage device, and
a configuration unit to configure the write control unit with the first control data stored in the control data storage unit when the first control data has a newer version number than that of the second control data received by the input reception unit, and with the second control data when the second control data has a newer version number than that of the first control data.
